(19) United States
(12) Patent Application Publication
(10) Pub. No.: US 2016/0303524 A1
(43) Pub. Date: Oct. 20, 2016

(54) POLYACRYLONITRILE/CHITOSAN COMPOSITE NANOFILTRATION MEMBRANE CONTAINING GRAPHENE OXIDE AND PREPARATION METHOD THEREOF

(71) Applicant: KOREA RESEARCH INSTITUTE OF CHEMICAL TECHNOLOGY, Daejeon (KR)

(72) Inventors: Saira BANO, Lahore (PK); Asif MAHMOOD, Daejeon (KR); Seong-Joong KIM, Daejeon (KR); Kew Ho LEE, Daejeon (KR)

(73) Assignee: KOREA RESEARCH INSTITUTE OF CHEMICAL TECHNOLOGY, Daejeon (KR)

(21) Appl. No.: 15/064,301

(22) Filed: Mar. 8, 2016

(30) Foreign Application Priority Data
Apr. 15, 2015 (KR) 10-2015-0053435

(51) Int. Cl. B01D 71/82; B01D 71/08; B01D 69/12; B01D 61/02; B01D 67/00; B01D 63/10; C02F 1/44; B01D 71/42

(52) U.S. Cl. CPC B01D 71/82; C02F 1/442; B01D 71/08; B01D 71/42; B01D 61/027; B01D 67/0006; B01D 63/10; B01D 69/125; C02F 2101/00

(57) ABSTRACT

Provided is a polyacrylonitrile/chitosan composite nanofiltration membrane, including: a polyacrylonitrile support; and a chitosan coating layer modified with graphene oxide, or a polyacrylonitrile/chitosan composite nanofiltration membrane, including: a polyacrylonitrile support modified with graphene oxide; and a chitosan coating layer or chitosan coating layer modified with graphene oxide. The polyacrylonitrile/chitosan composite nanofiltration membrane containing graphene oxide shows high permeability and a high salt rejection ratio, has excellent anti-fouling property and chlorine resistance, and thus may be manufactured in the form of a spirally wound type membrane module applied to a water treatment system so that it may be utilized for an actual nanofiltration separation process.

### CROSS-REFERENCE TO RELATED APPLICATIONS

This application claims priority under 35 U.S.C. §119 to Korean Patent Application No. 10-2015-0053435 filed on Apr. 15, 2015 in the Korean Intellectual Property Office, the disclosure of which is incorporated herein by reference in its entirety.

### TECHNICAL FIELD

The following disclosure relates to a polyacrylonitrile/chitosan composite nanofiltration membrane containing graphene oxide and a method for preparing the same. More particularly, the following disclosure relates to preparation of a polyacrylonitrile/chitosan composite nanofiltration membrane modified with graphene oxide and application thereof to water treatment industry.

### BACKGROUND

Recently, many attentions have been given to nanofiltration membranes in the field of water purification technology which essentially requires complete removal of dye materials from industrial waste water or securement of stable supply of public drinking water using, as crude water, surface water or groundwater from which agricultural chemicals or other organic contaminants are to be removed. Such nanofiltration membranes are those positioned in the middle of reverse osmosis membranes and ultrafiltration membranes based on the classification according to pore sizes. Such nanofiltration membranes are driven under a lower pressure condition as compared to a reverse osmosis membrane process and allow filtration of a part of salts, including organic materials. Thus, a nanofiltration membrane process is also referred to as a low-pressure reverse osmosis membrane process in its nature. In other words, since the purity of water produced after filtration does not show a fineness corresponding to ultrapure water required for a semiconductor process or pharmaceutical industry, nanofiltration membranes are used for some applications not requiring a high-efficiency reverse osmosis process obstinately.

Active studies have been conducted about development of nanofiltration membranes having excellent water permeability and a high salt rejection ratio to meet such applications. The inventors of the present disclosure have already developed a polyamide-based composite membrane having a salt rejection ratio required for the field of nanofiltration membranes or reverse osmosis membranes and high water permeability at the level of nanofiltration, and have registered it as patent. Such a composite membrane may increase throughput per unit time and provide increased efficiency during a water treatment process, resulting in high cost efficiency. However, due to the characteristics of such a polyamide-based composite membrane, it shows low chlorine resistance and is susceptible to fouling. Therefore, actual application of the polyamide-based composite membrane to large-scale water treatment industry is limited (Patent Document 1).

Meanwhile, it is known that graphene is a two-dimensional material of a nanoplate structure including a single carbon atom layer having a hexagonal honeycomb-like shape, shows excellent physicochemical properties, and has high mechanical strength although it is a single atom layer. However, in the case of the polymer composites including graphene or graphene oxide according to the related art, dispersibility and compatibility between graphene or graphene oxide and the polymer are low, resulting in a limitation in commercialization (Non-Patent Document 1).

In addition, a composite membrane having a higher permeation flux as compared to the conventional nanofiltration membranes and an excellent salt rejection ratio has been developed by coating a nanofibrous polyacrylonitrile substrate with chitosan. However, in this case, the composite membrane shows poor stability due to the brittleness and rough surface characteristics unique to a polyacrylonitrile-based membrane, and thus is expected to have a limitation in commercialization (Non-Patent Document 2).

Further, a chitosan nanocomposite membrane crosslinked with graphene oxide has been studied. The nanocomposite membrane shows significantly increased strength by virtue of the incorporation of graphene oxide. This makes it possible to apply such a nanocomposite membrane to a separation process. However, there is no disclosure about the evaluation of the physical properties and separation quality of the nanocomposite membrane as a nanofiltration membrane (Non-Patent Document 3).

Therefore, the inventors of the present disclosure have conducted many studies and found that a polyacrylonitrile/chitosan composite membrane containing graphene oxide shows significantly improved hydrophilicity, permeability and mechanical properties by virtue of the incorporation of graphene oxide, provides an increased anti-fouling effect and significant improvement of durability for a long time, and thus may be applied to various industrial fields in which a nanofiltration process is applied actually. The present disclosure is based on this finding.

### REFERENCES

### Patent Document

Patent Document 1. Korean Patent Publication No. 10-1487764

### Non-Patent Document

Non-Patent Document 1. Hyunwoo Kim et al., Macromolecules, 43, 6515-6530(2010)

Non-Patent Document 2. Kyunghwan Yoon et al., Polymer 47, 2434-2441(2006)

Non-Patent Document 3. Lu Shao at al., Applied Surface Science, 280, 989-992(2013)

### SUMMARY

An embodiment of the present disclosure is directed to providing a polyacrylonitrile/chitosan composite nanofiltration membrane containing graphene oxide that shows high permeability and a high salt rejection ratio and has excellent anti-fouling property and chlorine resistance, and a method for preparing the same.

In one aspect, there is provided a polyacrylonitrile/chitosan composite nanofiltration membrane, including: a polyacrylonitrile support; and a chitosan coating layer modified with graphene oxide.

In another aspect, there is provided a polyacrylonitrile/chitosan composite nanofiltration membrane, including: a polyacrylonitrile support modified with graphene oxide; and a chitosan coating layer or chitosan coating layer modified with graphene oxide.

According to an embodiment, the graphene oxide is functionalized graphene oxide whose hydroxyl, carboxyl, carbonyl or epoxy group is converted into an ester, ether, amide or amino group.

According to another embodiment, the polyacrylonitrile/chitosan composite nanofiltration membrane includes graphene oxide in an amount of 1 wt %-10 wt %.

According to still another embodiment, chitosan is present in the polyacrylonitrile/chitosan composite nanofiltration membrane in an amount of 0.1 wt %-2 wt %.

In still another aspect, there is provided a method for preparing a polyacrylonitrile/chitosan composite nanofiltration membrane, including the steps of: I) dissolving chitosan into an aqueous acetic acid solution containing graphene oxide to obtain a film-forming solution; and II) coating a polyacrylonitrile support with the film-forming solution, followed by drying.

In still another aspect, there is provided a method for preparing a polyacrylonitrle/chitosan composite nanofiltration membrane, including the steps of: a) dissolving chitosan to an aqueous acetic acid solution or aqueous acetic acid solution containing graphene oxide to obtain a film-forming solution; and b) coating a polyacrylonitrile support modified with graphene oxide with the film-forming solution, followed by drying.

According to an embodiment, the graphene oxide is functionalized graphene oxide whose hydroxyl, carboxyl, carbonyl or epoxy group is converted into an ester, ether, amide or amino group.

According to another embodiment, the film-forming solution in step I) or a) includes graphene oxide in an amount of 0.1 wt %-10 wt %.

According to still another embodiment, the film-forming solution in step I) or a) includes chitosan in an amount of 0.1 wt %-2 wt %.

According to still another embodiment, the method further includes carrying out crosslinking of the dried membrane with a glutaraldehyde solution, after step II) or b).

According to yet another embodiment, the glutaraldehyde solution has a concentration of 0.1 wt %-5 wt %.

In still another aspect, there is provided a spirally wound type membrane module including the polyacrylonitrile/chitosan composite nanofiltration membrane.

In yet another aspect, there is provided a water treatment system including the spirally wound type membrane module.

The polyacrylonitrile/chitosan composite nanofiltration membrane containing graphene oxide according to the present disclosure shows high permeability and a high salt rejection ratio and has excellent antifouling property and chlorine resistance, and thus may be manufactured in the form of a spirally wound membrane module and applied to a water treatment system in which it may be utilized for an actual nanofiltration separation process.

### BRIEF DESCRIPTION OF THE DRAWINGS

FIG. 1 is a schematic view illustrating the hydrogen bonding between chitosan (CS) and graphene oxide (GO), formation of a crosslinked structure, or the like.

FIG. 2 shows the spectrum of each of the polyacrylonitrile/chitosan composite membranes obtained from Examples 1-3 and Comparative Example, as determined by Fourier Transform Infrared Spectroscopy (FTIR).

FIG. 3 shows the Raman spectrum of each of the polyacrylonitrile/chitosan composite membranes obtained from Examples 1-3 and Comparative Example.

FIG. 4A shows the scanning electron microscopic (SEM) sectional image of the polyacrylonitrile/chitosan composite membrane obtained from the Comparative Example.

FIG. 4B shows the scanning electron microscopic (SEM) surface image of the polyacrylonitrile/chitosan composite membrane obtained from the Comparative Example.

FIG. 4C shows the scanning electron microscopic (SEM) sectional image of the polyacrylonitrile/chitosan composite membranes obtained from Example 1.

FIG. 4D shows the scanning electron microscopic (SEM) surface image of the polyacrylonitrile/chitosan composite membranes obtained from Example 1.

FIG. 4E shows the scanning electron microscopic (SEM) sectional image of the polyacrylonitrile/chitosan composite membranes obtained from Example 3.

FIG. 4F shows the scanning electron microscopic (SEM) surface image of the polyacrylonitrile/chitosan composite membranes obtained from Example 3.

FIG. 4G shows the scanning electron microscopic (SEM) sectional image of the polyacrylonitrile/chitosan composite membranes obtained from Example 2.

FIG. 4H shows the scanning electron microscopic (SEM) surface image of the polyacrylonitrile/chitosan composite membranes obtained from Example 2.

FIG. 5A shows the transmission electron microscopic (TEM) image of a polyacrylonitrile/chitosan composite membrane obtained from the Comparative Example.

FIG. 5B shows the transmission electron microscopic (TEM) image of a polyacrylonitrile/chitosan composite membrane obtained from Example 3.

FIG. 5C shows the transmission electron microscopic (TEM) image of a polyacrylonitrile/chitosan composite membrane obtained from Example 1.

FIG. 5D shows the transmission electron microscopic (TEM) image of a polyacrylonitrile/chitosan composite membrane obtained from Example 2.

FIG. 6 is a graph illustrating the effect of chitosan upon a permeation flux and a rejection ratio as a function of concentration of chitosan, when the concentration of chitosan is varied in the PAN-GO/CS composite membrane obtained from Example 3.

FIG. 7A is a graph illustrating the effect of glutaraldehyde (GA) upon a permeation flux and a rejection ratio as a function of concentration of GA, when the concentration of GA is varied in the PAN/CS-GO composite nanofiltration membranes is crosslinked with GA according to Example 4.

FIG. 7B is a graph illustrating the effect of glutaraldehyde (GA) upon a permeation flux and a rejection ratio as a function of concentration of GA, when the concentration of GA is varied in the PAN-GO/CS-GO composite nanofiltration membranes is crosslinked with GA according to Example 4.

FIG. 8A is a graph illustrating the effect of content of graphene oxide upon a permeation flux and rejection ratio in the polyacrylonitrile/chitosan composite membranes of Example 1 obtained by using a different amount of graphene.

FIG. 8B is a graph illustrating the effect of content of graphene oxide upon a permeation flux and rejection ratio in the polyacrylonitrile/chitosan composite membranes of Example 2 obtained by using a different amount of graphene oxide.

FIG. 9 is a graph illustrating the dye rejection characteristics of each of the polyacrylonitrile/chitosan composite membranes obtained from Examples 1 and 2 and Comparative Example (concentration of feed: 100 ppm).

FIG. 10 is a graph illustrating the long-term stability against chlorine of each of the polyacrylonitrile/chitosan composite membranes obtained from Examples 1-3 and Comparative Example.

FIG. 11 is a graph illustrating the anti-fouling property of each of the polyacrylonitrile/chitosan composite membranes obtained from Examples 1-3 and Comparative Example [feed=200 ppm humic acid+20 ppm calcium chloride (CaCl₂)].

### DETAILED DESCRIPTION OF EMBODIMENTS

The advantages, features and aspects of the polyacrylonitrile/chitosan composite membrane containing graphene oxide and the method for preparing the same according to the present disclosure will become apparent from the following description of the embodiments with reference to the accompanying drawings, which is set forth hereinafter.

In one aspect, there is provided a polyacrylonitrile/chitosan composite nanofiltration membrane, including: a polyacrylonitrile support; and a chitosan coating layer modified with graphene oxide.

In another aspect, there is provided a polyacrylonitrile/chitosan composite nanofiltration membrane, including: a polyacrylonitrile support modified with graphene oxide; and a chitosan coating layer or chitosan coating layer modified with graphene oxide.

In the case of the polymer composite including graphene or graphene oxide (GO) according to the related art, the dispersibility and compatibility between graphene or graphene oxide and a polymer are low, and thus the commercialization of such polymer composites is limited. Particularly, it almost never have happened that such polymer composites are manufactured in the form of a membrane to be applied to an ultrafiltration process. However, according to the present disclosure, a polyacrylonitrile (PAN) support is coated with chitosan or chitosan modified with graphene oxide to obtain a polyacrylonitrile/chitosan composite membrane, and the obtained composite membrane is applied to a nanofiltration process in which it shows excellent separation quality.

In general, a pure PAN membrane is lack of stability as a separation membrane for water treatment due to its unique brittleness and rough surface characteristics. A polyamide-based composite membrane that has been used to date as a material for a nanofiltration or reverse osmosis membrane shows poor chlorine resistance and low anti-fouling property. Under these circumstances, in order to solve the above-mentioned problems, the technical gist of the present disclosure is incorporating graphene oxide to a support or active layer, when preparing a composite membrane (PAN/CS) by combining PAN with chitosan that has been studied and developed recently as a material for a separation membrane for water treatment.

In other words, since a nanofiltration membrane including PAN/CS alone is susceptible to fouling, graphene oxide is introduced to a support or active layer according to the present disclosure to enhance hydrophilicity, and to control the surface roughness of the membrane, thereby increasing the resistance against contaminants.

Graphene oxide used herein may be prepared in a great amount by oxidizing graphite with an oxidant, and contains a hydrophilic functional group, such as hydroxyl, carboxyl, carbonyl or epoxy group. Recently, graphene oxide has been prepared largely according to the Hummers' method [Hummers, W. S. & Offeman, R. E. Preparation of graphite oxide. J. Am. Chem. Soc. 80, 1339 (1958)] or a partially modified Hummers' method. According to the present disclosure, graphene oxide is obtained by a modified Hummers' method.

In addition, graphene oxide may be functionalized graphene oxide in which the hydrophilic functional group, such as hydroxyl, carboxyl, carbonyl or epoxy group, chemically reacts with another compound to be converted into an ester, ether, amide or amino group. For example, such functionalized graphene oxide may include one in which a carboxyl group of graphene oxide reacts with an alcohol to be converted into an ester group, a hydroxyl group of graphene oxide reacts with an alkyl halide to be converted into an ether group, a carboxyl group of graphene oxide reacts with an alkyl amine to be converted into an amide group, or an epoxy group of graphene oxide is subjected to ring opening with an alkyl amine to be converted into an amino group.

In addition, the graphene oxide may be present in the polyacrylonitrile/chitosan composite nanofiltration membrane in an amount of 0.1 wt %-10 wt %. When the amount of graphene oxide is less than 0.1 wt %, it is not possible to improve hydrophilicity sufficiently. When the amount of graphene oxide is greater than 10 wt %, it is difficult for graphene oxide to be dispersed homogenously in the polymer matrix and it is difficult to control the morphology, resulting in fouling and degradation of a permeation flux and a salt rejection ratio.

Further, chitosan may be present in the polyacrylonitrile/chitosan composite nanofiltration membrane in an amount of 0.1 wt %-2 wt %, more particularly 1 wt %-1.5 wt %, in view of a high permeation flux and a high salt rejection ratio.

In still another aspect, there is provided a method for preparing a polyacrylonitrile/chitosan composite nanofiltration membrane, including the steps of: I) dissolving chitosan into an aqueous acetic acid solution containing graphene oxide to obtain a film-forming solution; and II) coating a polyacrylonitrile support with the film-forming solution, followed by drying.

In still another aspect, there is provided a method for preparing a polyacrylonitrle/chitosan composite nanofiltration membrane, including the steps of: a) dissolving chitosan to an aqueous acetic acid solution or aqueous acetic acid solution containing graphene oxide to obtain a film-forming solution; and b) coating a polyacrylonitrile support modified with graphene oxide with the film-forming solution, followed by drying.

According to an embodiment, the graphene oxide is obtained by a modified Hummers' method as mentioned above, and may be functionalized graphene oxide whose hydroxyl, carboxyl, carbonyl or epoxy group is converted into an ester, ether, amide or amino group.

According to another embodiment, the aqueous acetic acid solution in step I) or a) may be 1-5 wt % of aqueous acetic acid solution, particularly 2 wt % of aqueous acetic acid solution, considering the solubility depending on molecular weight of chitosan.

According to still another embodiment, the amount of graphene oxide in the film-forming solution in step I) or a) may be controlled to 0.1 wt %-10 wt %, considering the physical properties, separation quality and easy film-forming property of the target polyacrylonitrile/chitosan composite nanofiltration membrane.

According to yet another embodiment, the amount of chitosan in the film-forming solution in step I) or a) may be 0.1 wt %-2 wt %, particularly 1 wt %-1.5 wt %, in view of a high permeation flux and a high salt rejection ratio of polyacrylonitrile/chitosan composite nanofiltration membrane.

Meanwhile, the method may further include a step of carrying out crosslinking of the dried membrane with a glutaraldehyde solution, after step II) or b), in order to improve the mechanical properties of the polyacrylonitrile/chitosan composite nanofiltration membrane obtained as described above. Herein, the glutaraldehyde solution may have a concentration of 0.1 wt %-5 wt %. When the concentration of glutaraldehyde solution is less than 0.1 wt %, it is not possible to improve mechanical properties sufficiently and the salt rejection ratio may be degraded. When the concentration of glutaraldehyde solution is higher than 5 wt %, the permeation flux may be decreased significantly depending on an increase in crosslinking degree.

In still another aspect, there is provided a spirally wound type membrane module including the polyacrylonitrile/chitosan composite nanofiltration membrane. In addition, the spirally wound type membrane module may be incorporated to a water treatment system so that it may be applied to an actual nanofiltration process.

The examples and experiments will now be described with reference to the accompanying drawings.

### Preparation Example

### Preparation of PAN and PAN-GO Support Membranes

First, graphene oxide (GO) obtained by the known modified Hummers' method is added to dimethyl formamide in an amount of 1 wt % and ultrasonication is carried out for 1 hour to obtain a homogenous dispersion. Polyacrylonitrile (PAN) is dissolved into the dispersion at 70° C. to a concentration of 20 wt % and the mixture is agitated for 12 hours and subjected to ultrasonication for 1 hour to obtain a homogenous casting solution. The casting solution is cast onto a substrate that is a glass plate having a polyester non-woven web attached thereto by using a doctor blade to a knife gap of 200 μm. Then, the substrate is dipped into a solidification bath containing water at 20° C. to carry out phase transition. After that, the remaining solvent is removed and dried to obtain a PAN-GO support membrane. Meanwhile, a pure PAN support membrane containing no graphene oxide is obtained in the same phase transition process as the above described Preparation Example, except that incorporation of graphene oxide is omitted.

### Example 1

### Preparation of PAN/CS-GO Composite Nanofiltration Membrane

Graphene oxide is dissolved into 2 wt % aqueous acetic acid solution containing graphene oxide to obtain a film-forming solution (graphene oxide content in the film-forming solution: 1 wt %, concentration of chitosan: 1 wt %). The film-forming solution is filtered under vacuum to remove non-dissolved impurities, followed by deaeration and removal of air bubbles. The solution is coated onto the pure PAN support membrane obtained from the above Preparation Example by using 2M sodium hydroxide at 40° C. for 1 hour, followed by drying, to obtain a composite membrane, which is designated as PAN/CS-GO.

### Example 2

### Preparation of PAN-GO/CS-GO Composite Nanofiltration Membrane

A composite membrane is obtained in the same manner as Example 1, except that the PAN-GO support membrane obtained from the above Preparation Example is used as a support membrane. The composite membrane is designated as PAN-GO/CS-GO.

### Example 3

### Preparation of PAN-GO/CS Composite Nanofiltration Membrane

A composite membrane is obtained in the same manner as Example 2, except that chitosan is dissolved into 2 wt % of an aqueous acetic acid solution (containing no graphene oxide) to provide a film-forming solution. The composite membrane is designated as PAN-GO/CS.

### Example 4

### Preparation of PAN/CS-GO and PAN-GO/CS-GO Composite Nanofiltration Membranes Crosslinked with Glutaraldehyde

PAN/CS-GO obtained from Example 1 and PAN-GO/CS-GO obtained from Example 2 are crosslinked with a glutaraldehyde solution having a different concentration (0.1 wt %, 0.25 wt %, 0.5 wt %, 1.5 wt %, 2.5 wt % and 5 wt %) to obtain PAN/CS-GO and PAN-GO/CS-GO composite nanofiltration membranes crosslinked with glutaraldehyde.

### Comparative Example

### Preparation of PAN/CS Composite Nanofiltration Membrane

A composite membrane is obtained in the same manner as Example 1, except that chitosan is dissolved into 2 wt % of an aqueous acetic acid solution (containing no graphene oxide) to provide a film-forming solution. The composite membrane is designated as PAN/CS.

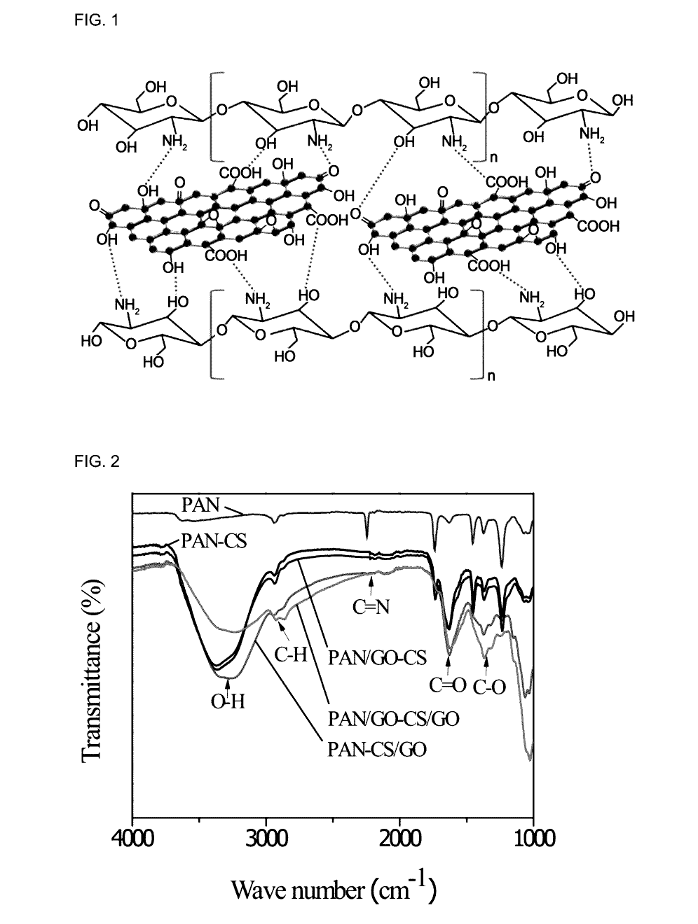

As can be seen from FIG. 1, chitosan (CS) and graphene oxide (GO) interact with each other through hydrogen bonding, formation of a crosslinked structure, or the like. To determine this, FIG. 2 shows the spectrum of each of the polyacrylonitrile/chitosan composite membranes obtained from Examples 1-3 and Comparative Example, as determined by Fourier Transform Infrared Spectroscopy (FTIR).

The absorption peak of PAN at 2242 cm⁻¹ results from the stretching vibration of nitrile groups of PAN, and the peak at 1720 cm⁻¹ indicates that PAN is hydrolyzed into —COOH. When PAN is coated with a chitosan solution, the nitrile peaks disappear and the intensity of peak at 1720 cm⁻¹ increases, suggesting that carboxyl groups are bound to chitosan. PAN/CS and PAN-GO/CS show characteristic peaks unique to chitosan at 3370 cm⁻¹ (O—H stretching vibration overlapped with N—H stretching vibration), 2296 cm⁻¹ (stretching vibration of aliphatic C—H), 1586 cm⁻¹ (N—H bending vibration) and 1102 cm⁻¹ (cyclic ether bond). When the surface of a composite membrane is modified with GO, the peak at 3200 cm⁻¹ is broadened due to the free hydroxyl groups of GO. It is known that the chemical and spatial structures of CS are similar to those of cellulose having a number of pendant hydroxyl groups. There are many C—O groups and two hydroxyl groups present at the end. Therefore, it is thought that the above results are derived from the synergic effect of hydrogen bonding between CS and oxygen-containing groups of GO and electrostatic interaction between the polycationic portions of CS and negative charges of the GO surface.

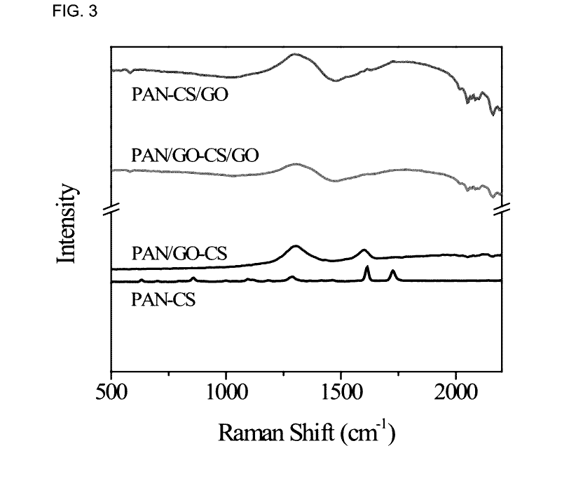

In addition, the effect of the above-mentioned interactions upon the molecular structures of the materials present in a composite membrane through Raman spectroscopy. As shown in FIG. 3 illustrating the Raman spectrum of each of the polyacrylonitrile/chitosan composite membranes obtained from Examples 1-3 and Comparative Example, PAN/CS shows no D band and G band of GO but PAN-GO/CS shows D band at 1302 cm⁻¹ and G band at 1600 cm⁻¹, suggesting that GO is present in the composite membrane. The surface-modified chitosan membrane shows broad D band and G band shifted slightly toward the longer wavelength side due to the hydrogen bonding interaction between chitosan and GO. While chitosan, a polysaccharide, is adhered to the graphene sheets via covalent bonding, D band and G band are shifted, broadened and increased. However, the most significant change in the Raman spectrum is observed in 2D band. As mentioned earlier, this band is sensitive to a change in graphene sheets and the broadening of this band is clearly related with a change occurring in the graphene oxide layer due to the bonding with chitosan.

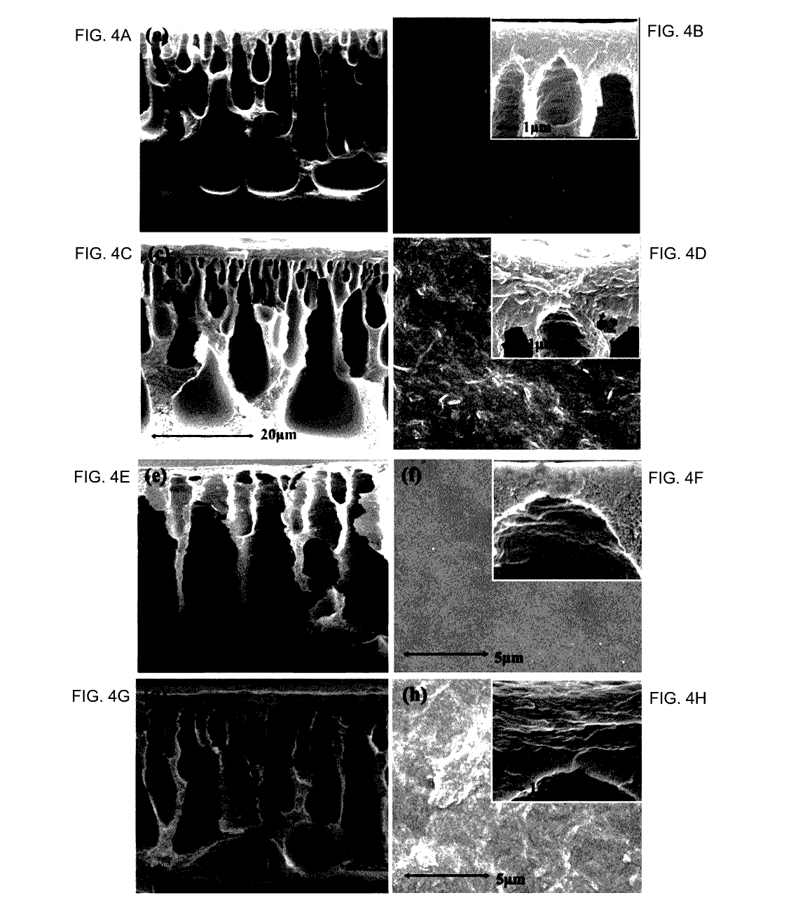

In addition, FIGS. 4A and 4B show the scanning electron microscopic (SEM) images of the surface and section of each of the polyacrylonitrile/chitosan composite membranes obtained from the Comparative Example. FIGS. 4C and 4D show the scanning electron microscopic (SEM) images of the surface and section of each of the polyacrylonitrile/chitosan composite membranes obtained from Example 1. FIGS. 4A and 4F show the scanning electron microscopic (SEM) images of the surface and section of each of the polyacrylonitrile/chitosan composite membranes obtained from Example 3. FIGS. 4G and 4H show the scanning electron microscopic (SEM) images of the surface and section of each of the polyacrylonitrile/chitosan composite membranes obtained from Example 2. As shown in FIG. 4B, the surface of PAN/CS shows a band-like structure. This is because chitosan tends to self-agglomerate in solution. It can be seen that the PAN/CS membrane in FIG. 4B and the PAN-GO/CS membrane in FIG. 4F have a soft surface. The reason why the image seems dark is that chitosan is not conductive. A light portion is observed in FIG. 4D and FIG. H. This is because GO is present in the active layer. In addition, when the sectional structure of the PAN/CS membrane in FIG. 4B is observed, no significant boundary layer appears between the dense active layer and the PAN support membrane, suggesting that the interfacial interaction between the two ingredients is not affected. The dispersion state of GO sheets in the CS matrix is much better as compared to the carbon nanotubes dispersed in a CS matrix according to the related art. A composite membrane forming a crosslinked structure with GO shows more wrinkles and grooves in its sectional image as compared to the pure CS membrane. As the amount of GO increases, roughness caused by surface cracking also increases. Such a sectional structure suggests that CS forming a crosslinked structure has higher roughness.

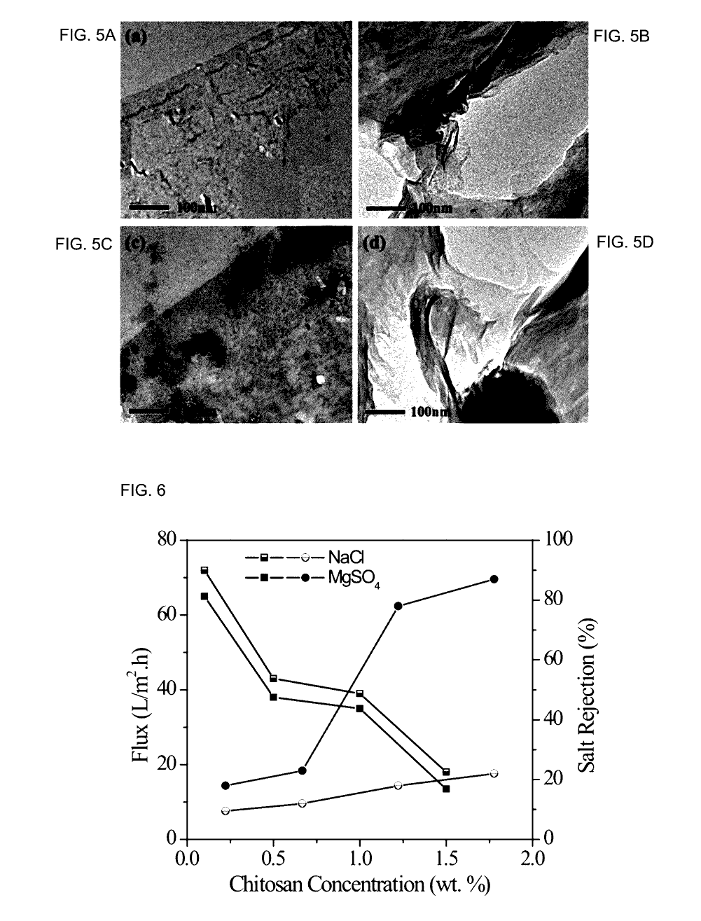

Further, the dispersion state of GO in the CS membrane is investigated by using transmission electron microscopy (TEM). FIG. 5A shows the TEM image of each of the polyacrylonitrile/chitosan composite membranes obtained from the Comparative Example. FIG. 5B shows the TEM image of each of the polyacrylonitrile/chitosan composite membranes obtained from Example 3. FIG. 5C shows the TEM image of each of the polyacrylonitrile/chitosan composite membranes obtained from Example 1. FIG. 5D shows the TEM image of each of the polyacrylonitrile/chitosan composite membranes obtained from Example 2. The pure PAN/CS membrane is soft and has no significant layered structure. On the contrary, in the case of the PAN/CS-GO and PAN-GO/CS-CO composite membranes, it can be seen that GO sheets are dispersed homogenously in the polymer matrix without agglomeration.

In addition, FIG. 6 is a graph illustrating the effect of chitosan upon a permeation flux and rejection ratio as a function of concentration of chitosan, when the concentration of chitosan is varied in the PAN-GO/CS composite membrane obtained from Example 3. In general, as the CS concentration increases, the permeation flux decreases. The concentration of a polymer has a significant effect upon the thickness of an active layer in a composite membrane, and the thickness of an active layer determines the permeability of a membrane. When concentration of chitosan is low, a very thin active layer is formed to increase the permeation flux but rejection characteristics are poor. In the case of a diluted chitosan solution, defects may be generated on the membrane surface. As shown in FIG. 6, 1.5 wt % of CS concentration seems to be an optimized concentration, where a permeation flux of 30 L/m²h and a rejection ratio of MgSO₄ of 80% are provided.

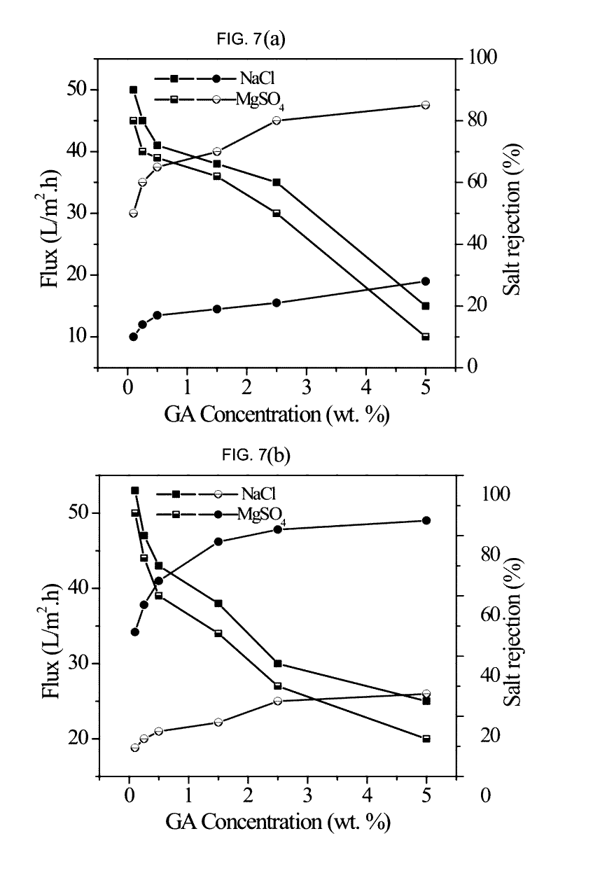

Further, FIG. 7A is a graph illustrating the effect of glutaraldehyde (GA) upon a permeation flux and rejection ratio as a function of concentration of GA, when the concentration of GA is varied in the PAN/CS-GO composite nanofiltration membranes crosslinked with GA according to Example 4. FIG. 7B is a graph illustrating the effect of glutaraldehyde (GA) upon a permeation flux and rejection ratio as a function of concentration of GA, when the concentration of GA is varied in the PANGO/CS-GO composite nanofiltration membranes crosslinked with GA according to Example 4. As shown in FIG. 7B, it is observed that as the GA concentration increases, the permeation flux decreases and the rejection ratio increases. A decrease in permeation flux results from the combination of increased hydrophobicity, decreased expansion (i.e. pore shrinking) and diffusion through the pores inside of a membrane, i.e. increased bending ratio. Such a phenomenon is more clearly observed in the PAN/CS-GO membrane. In brief, as the GA concentration increases, the permeation flux decreases. As the GA concentration increases, the rejection ratios of two inorganic salts increase. When the GA concentration increases, the expansion in water decreases (i.e. pore size is decreased), resulting in an increase in salt rejection ratio. As can be seen from such decreased expansion in water, it can be said that an increase in hydrophobicity of a membrane by virtue of crosslinking increases rejection characteristics through the repulsion against water with which salt ions are hydrated. In addition, rejection against divalent MgSO₄ is better as compared to monovalent NaCl ions. It is thought that this results from the size exclusion principle.

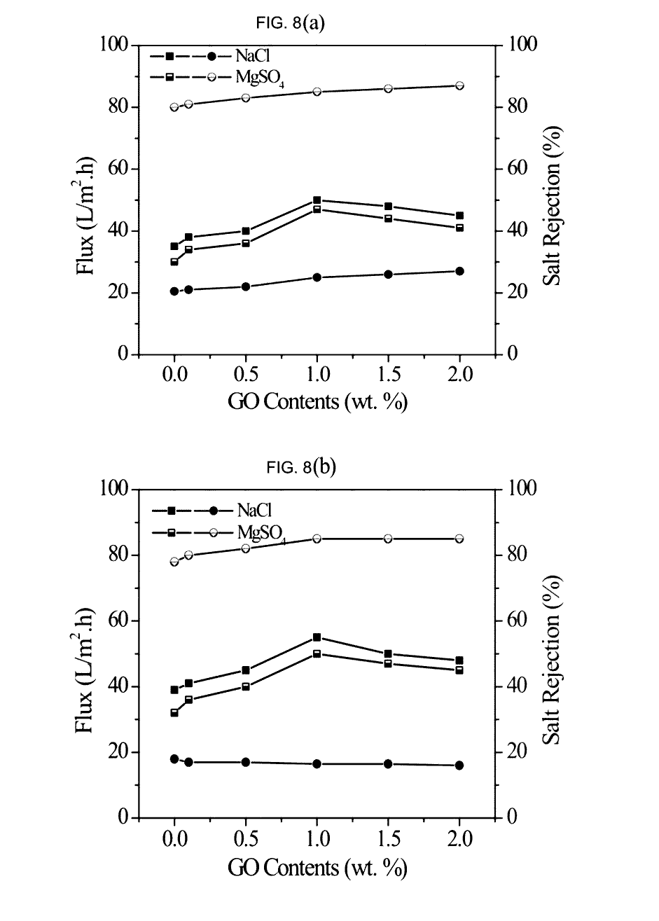

Meanwhile, FIG. 8A is a graph illustrating the effect of content of graphene oxide upon a permeation flux and rejection ratio in the polyacrylonitrile/chitosan composite membranes of Examples 1 and 2 obtained by using a different amount of graphene oxide according to Example 1. FIG. 8B is a graph illustrating the effect of content of graphene oxide upon a permeation flux and rejection ratio in the polyacrylonitrile/chitosan composite membranes of Examples 1 and 2 obtained by using a different amount of graphene oxide according to Example 2. As shown in FIG. 8B, as the GO content increases (up to 1%), the permeation flux increases. Such an increase in permeation flux of water according to an increase in GO content is related with various factors. Incorporation of GO increases the hydrophilicity of a membrane, and thus increases the water permeability. In addition, when the hydrophilicity of a membrane increases, water molecules are drawn into the membrane matrix and permeation through the membrane is stimulated, resulting in an increase in water permeability. Further, the other factors are as follows. First, GO may provide an additional path through which water molecules pass. Second, movement of GO interrupts packing of polymer chains, resulting in an increase in free volume. Third, when GO is incorporated, voids are formed inevitably in the thin film layer at the GO/polymer interface, However, it is observed that when the GO concentration increases more, the permeation flux decreases. It is thought that such a slight decrease in permeation flux results from agglomeration of GO under a high concentration of GO.

In addition, 2000 ppm of NaCl and MgSO₄ are used to examine the effect of GO upon permeability of CS membrane in relation with salt rejection characteristics. As the GO content increases, the permeation flux of salt solution increases with no specific change in rejection characteristics of the membrane. The PAN/CS-GO and PAN-GO/CS-GO membranes maintain a rejection ratio of NaCl at 18%. However, when the GO content is 1 wt %, the rejection ratio of MgSO₄ increases slightly. It is thought that such an increase in rejection ratio of divalent ions results from the negatively charged groups on the GO surface pushing out divalent SO₄²⁻. As expected, the salt rejection ratio decreases in the order of MgSO₄>NaCl. It is thought that the rejection ratio of MgSO₄ higher than that of NaCl results from the combination of electrostatic repulsion with a size exclusion effect.

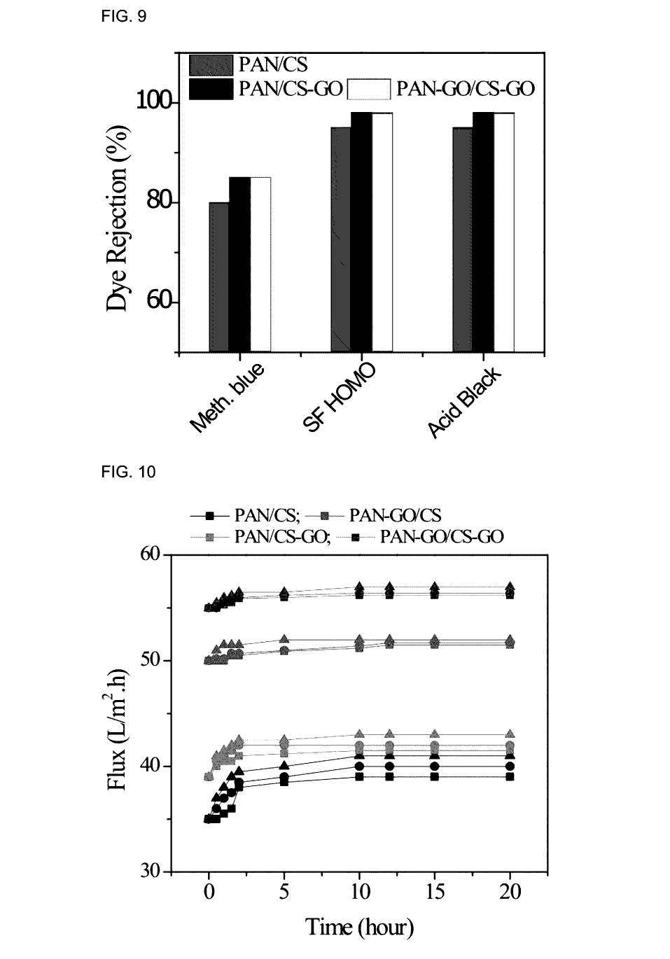

Further, FIG. 9 is a graph illustrating the dye rejection characteristics of each of the polyacrylonitrile/chitosan composite membranes obtained from Examples 1 and 2 and Comparative Example (concentration of feed: 100 ppm). As shown in FIG. 9, the PAN/CS-GO composite membrane according to Example 1 and the PAN-GO/CS-GO composite membrane according to Example 2 show a higher dye retention ratio as compared to the PAN/CS membrane according to Comparative Example. The retention ratio is in the order of methyl blue (85%)<SF HOMO (97.5%)<Acid Black (98%). The above results may be explained by the Donnan repulsion force between the negatively charged membrane surface and anionic dye molecules. This means that incorporation of GO fillers is favorable to improvement of the selectivity of a membrane.

In addition, FIG. 10 is a graph illustrating the long-term stability against chlorine of each of the polyacrylonitrile/chitosan composite membranes obtained from Examples 1-3 and Comparative Example. In the case of a commercially available polyamide membrane, it is attacked by chlorine and chlorine resistance is an important factor determining durability. The polyacrylonitrile/chitosan composite membranes according to Examples 1-3 and Comparative Example are exposed to a different concentration (100 ppm, 300 ppm and 1000 ppm) of sodium hypochlorite (NaOCl) and tested for filtration characteristics to determine the chemical stability of each composite membrane. As shown in FIG. 10, the polyacrylonitrile/chitosan composite membranes according to Examples 1-3 show higher chlorine resistance as compared to the PAN/CS membrane according to Comparative Example, even after they are exposed to high-chlorine environment for a long time.

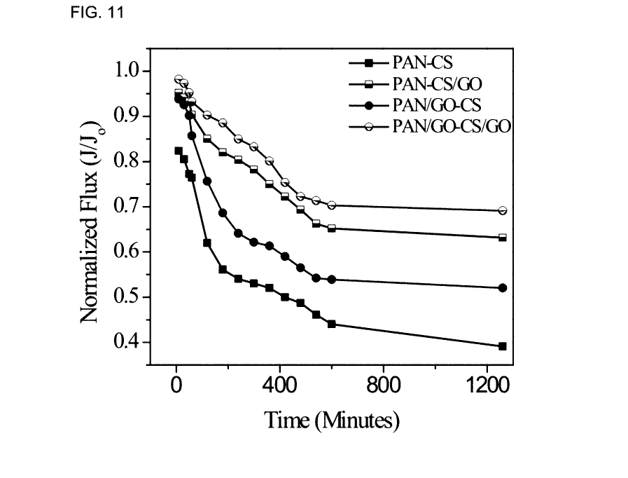

Further, FIG. 11 is a graph illustrating the anti-fouling property of each of the polyacrylonitrile/chitosan composite membranes obtained from Examples 1-3 and Comparative Example [feed=200 ppm humic acid+20 ppm calcium chloride (CaCl₂)]. It is generally known that fouling of a membrane is related with the surface structure and surface charges thereof. As shown in FIG. 11, the permeation flux of the PAN-GO/CS-GO membrane decreases slightly at the initial time, and then is maintained substantially. On the contrary, the chitosan membrane containing no GO undergoes a larger decrease in permeation flux with time. It is noted that the permeation flux of the GO-modified membrane is maintained at a higher level at any time, suggesting that addition of GO significantly improves the quality of a membrane. This means that incorporation of GO improves the anti-fouling property of membrane. It can be said that this is because incorporation of GO increases hydrophilicity. Since the surface adsorption characteristics of a membrane depend on hydrophilicity, an increase in hydrophilicity of a membrane may reduce fouling to a certain degree. In addition, hydrophilicity reduces adhesion of hydrophobic contaminant to the surface of a membrane. The roughness of a membrane is also an important factor affecting the fouling characteristics of a membrane. Addition of GO reduces the average surface roughness of a membrane. As a result, it is possible to reduce the effect of divalent cations present in humic acid solution. Therefore, addition of GO to a chitosan membrane not only increases permeability but also improves stability against fouling.

Therefore, the polyacrylonitrile/chitosan composite nanofiltration membrane containing graphene oxide according to the present disclosure shows a high permeability and a high salt rejection ratio, has excellent anti-fouling property and chlorine resistance, and thus may be manufactured in the form of a spirally wound type membrane module applied to a water treatment system so that it may be utilized for an actual nanofiltration separation process.

What is claimed is:

1. A polyacrylonitrile/chitosan composite nanofiltration membrane, comprising:
a polyacrylonitrile support; and
a chitosan coating layer modified with graphene oxide.

2. A polyacrylonitrile/chitosan composite nanofiltration membrane, comprising:
a polyacrylonitrile support modified with graphene oxide; and
a chitosan coating layer or chitosan coating layer modified with graphene oxide.

3. The polyacrylonitrile/chitosan composite nanofiltration membrane according to claim 1, wherein the graphene oxide is present in the polyacrylonitrile/chitosan composite nanofiltration membrane in an amount of 0.1 wt %-10 wt %.

4. The polyacrylonitrile/chitosan composite nanofiltration membrane according to claim 2, wherein the graphene oxide is present in the polyacrylonitrile/chitosan composite nanofiltration membrane in an amount of 0.1 wt %-10 wt %.

5. The polyacrylonitrile/chitosan composite nanofiltration membrane according to claim 1, wherein the chitosan is present in the polyacrylonitrile/chitosan composite nanofiltration membrane in an amount of 0.1 wt %-2 wt %.

6. The polyacrylonitrile/chitosan composite nanofiltration membrane according to claim 2, wherein the chitosan is present in the polyacrylonitrile/chitosan composite nanofiltration membrane in an amount of 0.1 wt %-2 wt %.

7. A method for preparing a polyacrylonitrile/chitosan composite nanofiltration membrane, comprising the steps of:
I) dissolving chitosan into an aqueous acetic acid solution containing graphene oxide to obtain a film-forming solution; and
II) coating a polyacrylonitrile support with the film-forming solution, followed by drying.

8. A method for preparing a polyacrylonitrle/chitosan composite nanofiltration membrane, comprising the steps of:
a) dissolving chitosan to an aqueous acetic acid solution or aqueous acetic acid solution containing graphene oxide to obtain a film-forming solution; and
b) coating a polyacrylonitrile support modified with graphene oxide with the film-forming solution, followed by drying.

9. The method for preparing a polyacrylonitrile/chitosan composite nanofiltration membrane according to claim 7, wherein the film-forming solution comprises graphene oxide in an amount of 0.1 wt %-10 wt %.

10. The method for preparing a polyacrylonitrile/chitosan composite nanofiltration membrane according to claim 8, wherein the film-forming solution comprises graphene oxide in an amount of 0.1 wt %-10 wt %.

11. The method for preparing a polyacrylonitrile/chitosan composite nanofiltration membrane according to claim 7, wherein the film-forming solution comprises chitosan in an amount of 0.1 wt %-2 wt %.

12. The method for preparing a polyacrylonitrile/chitosan composite nanofiltration membrane according to claim 8, wherein the film-forming solution comprises chitosan in an amount of 0.1 wt %-2 wt %.

13. The method for preparing a polyacrylonitrile/chitosan composite nanofiltration membrane according to claim 7, which further comprises carrying out crosslinking of the dried membrane with a glutaraldehyde solution, after step II).

14. The method for preparing a polyacrylonitrile/chitosan composite nanofiltration membrane according to claim 8, which further comprises carrying out crosslinking of the dried membrane with a glutaraldehyde solution, after step b).

15. The method for preparing a polyacrylonitrile/chitosan composite nanofiltration membrane according to claim 13, wherein the glutaraldehyde solution has a concentration of 0.1 wt %-5 wt %.

16. The method for preparing a polyacrylonitrile/chitosan composite nanofiltration membrane according to claim 14, wherein the glutaraldehyde solution has a concentration of 0.1 wt %-5 wt %.

17. A spirally wound type membrane module comprising the polyacrylonitrile/chitosan composite nanofiltration membrane as defined in claim 1.

18. A spirally wound type membrane module comprising the polyacrylonitrile/chitosan composite nanofiltration membrane as defined in claim 2.

19. A water treatment system comprising the spirally wound type membrane module as defined in claim 17.

20. A water treatment system comprising the spirally wound type membrane module as defined in claim 18.
